(19) United States
(12) Patent Application Publication
(10) Pub. No.: US 2009/0037695 A1
(43) Pub. Date: Feb. 5, 2009

(54) DATA FETCH CIRCUIT AND METHOD THEREOF

(75) Inventor: Ren-Hong Luo, Taipei City (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 11/833,769

(22) Filed: Aug. 3, 2007

(51) Int. Cl. G06F 9/38

(52) U.S. Cl. 712/205; 712/E09.055

(57) ABSTRACT

A data fetch circuit and a method thereof are provided. A multi-phase clock signal is generated according to an input clock, and an input data is over-sampled according to the multi-phase clock signal in order to detect transition points of the input data. One of reference phases of the multi-phase clock signal is selected according to the detected transition point for fetching the input data and obtaining enough setup/hold time margin. Accordingly, appropriate data fetch points is found without complicated negative feed-back mechanism. Besides, a periodical monitoring mechanism may be further adopted for improving the accuracy of data fetch.

### BACKGROUND OF THE INVENTION

1. Field of the Invention

The present invention generally relates to a data fetch circuit and a method thereof, in particular, to a data fetch circuit which selects appropriate data fetch points according to data transition points detected through over-sampling and a method thereof.

2. Description of Related Art

In a high-speed serial link system, mismatch of semiconductor processes or chip layouts may cause asynchrony or skew between clock signals and data received by a receiver.

FIG. 1 is a timing diagram of a clock signal and a data received by a receiver. As shown in FIG. 1, ideally, the data and the clock signal should be aligned, namely, the transition points of the data should be aligned with the rising edges of the clock signal. Accordingly, data fetching can be carried out at the falling edges of the clock signal.

Skews are produced when the data lags or leads the clock signal. When the skews are too large and accordingly the timing relationship between the data and the clock signal does not comply with the setup/hold time margin defined by the sampler, errors in data reception will be occurred. In other words, the receiver cannot decode the data correctly.

According to a prior art method for resolving foregoing problem, a phase locked loop (PLL) is used for generating desired clock signals. A plurality of clock signals having the same frequency but different phases is generated by a delay locked loop (DLL) according to the clock signal generated by the PLL, and a negative feedback mechanism is used for finding appropriate data fetch points.

However, the conventional technique described above has complicated hardware implementation, for it requires high-speed PLL or DLL. Besides, since skews at different transmission ports may not be the same, a dedicated negative feedback circuit is required by each transmission port, which also increases the design complexity. For long distance transmission of high-frequency multi-phase clock signals, the symmetry of transmission path, the matching between driving forces, and noise coupling issues have to be considered. Moreover, since the PLL/DLL takes up a lot of circuit space, therefore the fabricating cost of the circuit is increased. Furthermore, since most PLLs and DLLs are analog circuits, they are easily affected by process parameters, temperatures, and power supplies.

To resolve foregoing problems, the present invention provides a data fetch circuit which can prevent incorrect data fetch caused by skews and a method thereof.

### SUMMARY OF THE INVENTION

Accordingly, the present invention is directed to a data fetch circuit and a method thereof, wherein data reception errors caused by large skews between an input data and an input clock can be avoided.

The present invention is directed to a data fetch circuit and a method thereof, wherein inadequate sampling points introduced by skews between an input data and an input clock signal can be avoided without a negative feedback mechanism, so that the process uncertainty and fabricating cost of the circuit can be reduced.

One example of the present invention provides a data fetch circuit. The data fetch circuit includes an over-sampling unit, a transition detection unit, and a phase selection unit. The over-sampling unit generates a multi-phase clock signal having a plurality of reference phases according to an input clock, and the over-sampling unit over-samples an input data according to the reference phases. The transition detection unit detects a transition point of the input data. The phase selection unit selects one of the reference phases of the multi-phase clock signal according to the transition point detected by the transition detection unit, so that the over-sampling unit fetches the input data according to the selected reference phase.

In addition, the data fetch circuit further includes a control circuit for monitoring the over-sampling unit, the transition detection unit, and the phase selection unit, wherein the control circuit resets the over-sampling unit, the transition detection unit, and the phase selection unit periodically.

Moreover, another example of the present invention further provides a data fetch method. The method includes following steps. First, an input clock and an input data are received. The input clock is then delayed to generate a plurality of reference phases. After that, the input data is sampled according to the reference phases. Next, a transition point of the input data is detected. One of the reference phases is selected as a data fetch point according to the detected transition point. The input data is fetched according to the selected data fetch point.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a timing diagram of a clock signal and a data received by a receiver.

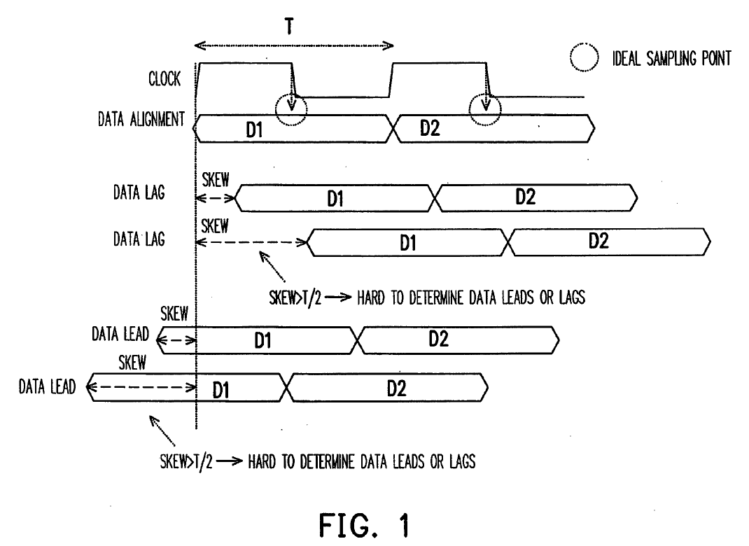

FIG. 2 is a diagram illustrating the selection of sampling points according to an embodiment of the present invention.

FIG. 3A illustrates a clock, data, and a plurality of reference phases (PHA˜PHD) respectively in high-speed and low-speed transmissions when a multi-phase clock signal is generated by a phase locked loop (PLL)/delay locked loop (DLL) according to the conventional technique.

FIG. 3B illustrates a clock, a data, and a plurality of reference phases (PHA˜PHD) respectively in high-speed and low-speed transmissions when a multi-phase clock signal is generated by a delay unit according to an embodiment of the present invention.

FIG. 4 illustrates correct data fetch and incorrect data fetch.

FIG. 5 is a diagram of a data fetch circuit according to an embodiment of the present invention.

FIG. 6 is a state diagram of a phase selection unit according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

According to an embodiment of the present invention, an input data is over-sampled according to a multi-phase clock signal, and a transition point of the input data is detected. Next, appropriate data fetch points are selected according to the transition point for fetching the input data. In the present embodiment, appropriate data fetch points can be obtained without using complicated negative feedback mechanism since various transmission ports have the same skew. In addition, a periodical monitoring mechanism is adopted in the present embodiment for improving the accuracy of data fetching.

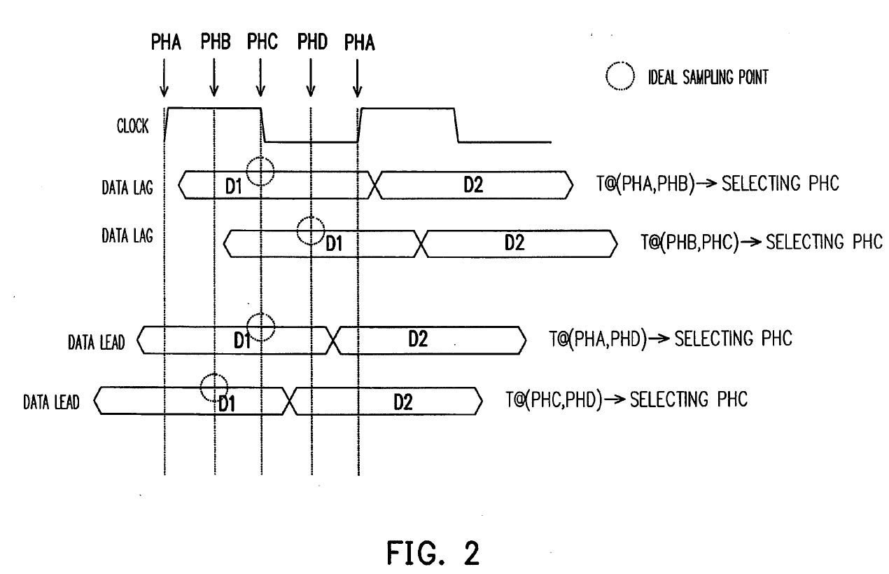

FIG. 2 is a diagram illustrating the selection of sampling points in the present embodiment. Referring to FIG. 2, PHA, PHB, PHC, and PHD represent the reference phases of a multi-phase clock signal. T@(PHA, PHB) represents a data transition point occurred between PHA and PHB, and so on.

When the data lags the clock, preferably, PHC is selected as the data fetch point if the transition point is between PHA and PHB, and PHD is selected as the data fetch point if the transition point is between PHB and PHC. When the data leads the clock, preferably, PHC is selected as the data fetch point if the transition point is between PHD and PHA, and PHB is selected as the data fetch point if the transition point is between PHC and PHD.

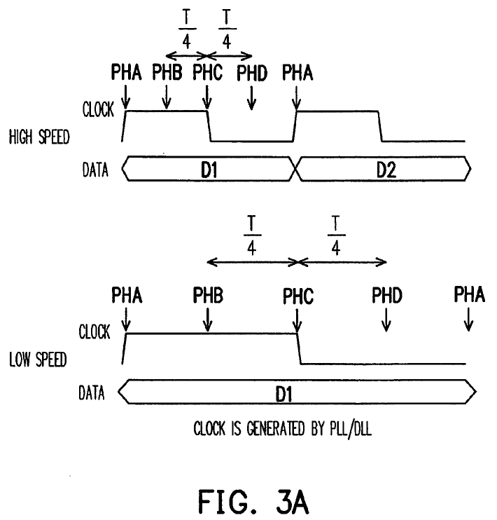

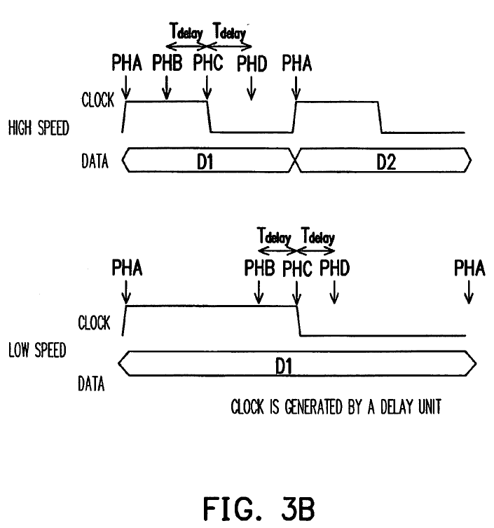

FIG. 3A illustrates the clock, data, and reference phases PHA-PHD respectively in high-speed and low-speed transmissions when the multi-phase clock signal is generated by a phase locked loop (PLL)/delay locked loop (DLL) (according to the conventional technique). As shown in FIG. 3A, the time differences between various phases are substantially T/4 regardless of high-speed or low-speed transmission, wherein T is a cycle of the clock signal and T changes along with the frequency of the clock signal and the transmission speed.

FIG. 3B illustrates the clock, data, and reference phases PHA˜PHD respectively in high-speed and low-speed transmissions when the multi-phase clock signal is generated by a delay unit (according to the present embodiment). As shown in FIG. 3B, the time difference between the reference phases PHB and PHC (or between the reference phases PHC and PHD) generated by the delay unit is substantially fixed to T_{delay} regardless of high-speed or low-speed transmission, wherein T_{delay} does not change along with the frequency of the clock signal and the transmission speed. The value of T_{delay} is generally related to the setup time and hold time of a data latch unit (for example, DFF). For example, the value of T_{delay} may be set as 2 times of the setup time of the data latch unit.

In addition, incorrect data fetch may take place if the transition point overlaps or is close to the setup time of the data latch unit. Thus, in the present embodiment, when it is detected that the transition point overlaps or is close to the setup time of the data latch unit, the data fetch point is moved to a later phase or the next phase in order to fetch data correctly.

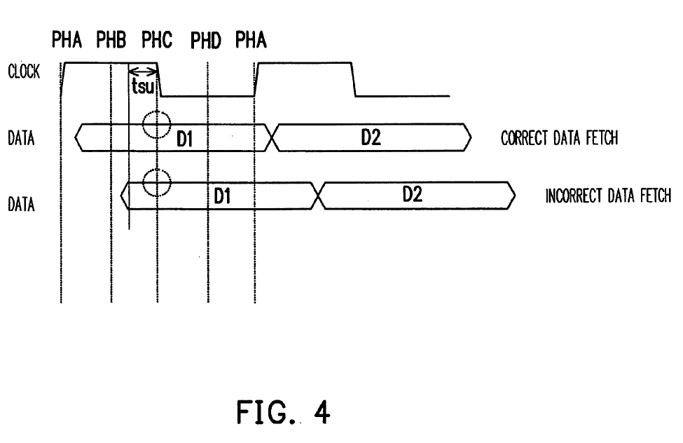

FIG. 4 illustrates correct data fetch and incorrect data fetch. The transition point is regarded as being within or close to the setup time of the data latch unit if it is detected that the transition point is between PHB and PHC. In this case, incorrect data fetch may take place if PHC is still used as the data fetch point. Thus, PHD is used instead as the data fetch point in order to avoid incorrect data fetch.

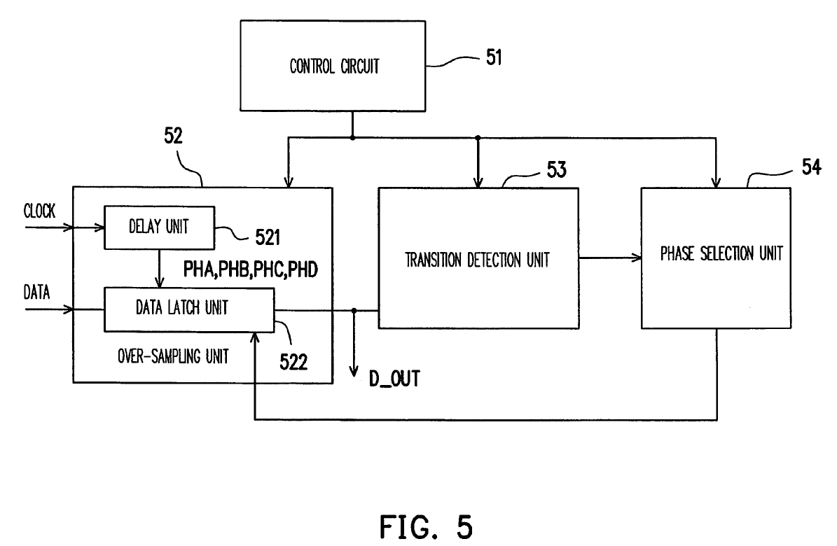

FIG. 5 is a diagram of a data fetch circuit in the present embodiment. Referring to FIG. 5, the data fetch circuit includes a control circuit 51, an over-sampling unit 52, a transition detection unit 53, and a phase selection unit 54. The over-sampling unit 52 includes a delay unit 521 and a data latch unit 522. In the present embodiment, all the component units in the data fetch circuit are digital circuits, thus, the data fetch circuit has high immunity to process drift.

The control circuit 51 sends a reset signal to the over-sampling unit 52, the transition detection unit 53, and the phase selection unit 54 at certain intervals (for example, every 16 clock cycles or even longer) to reset these units, and this is to increase the reliability of data fetching. For example, in the present embodiment, the selected data fetch point is not changed even when the transition point cannot be detected correctly; however, such situation may cause incorrect data fetch, and periodical reset can reduce the affection of foregoing situation.

The over-sampling unit 52 over-samples the input data. The delay unit 521 applies different delays to the input clock in order to generate a multi-phase clock signal. Here the multi-phase clock signal refers to a plurality of clock signals having the same frequency but different phases. Four clock signals having the same frequency but different phases will be described herein as an example. The falling edges of the four clock signals are respectively PHA, PHB, PHC, and PHD. Thus, in the present disclosure, the term “selecting PHA as the data fetch point” means the clock signal having the falling edge PHA is selected as the reference clock signal for data fetching, and so on.

The data latch unit 522 samples the input data according to the multi-phase clock signals PHA˜PHD. The output of the data latch unit 522 is input to the transition detection unit 53.

The transition detection unit 53 detects the sampling result of the over-sampling unit 52 to detect the transition point of the input data.

Below, the structures and operations of the data latch unit 522 and the transition detection unit 53 will be explained with an example. The data latch unit 522 may include four latching units DFF1˜DFF4. The latching unit DFF1 is triggered by PHA to latch the input data. The latching unit DFF2 is triggered by PHB to latch the input data. The latching unit DFF3 is triggered by PHC to latch the input data. The latching unit DFF4 is triggered by PHD to latch the input data. The transition detection unit 53 may include four logic units (for example, EXOR gates), wherein one of the logic units receives the output signals of the latching units DFF1 and DFF2, another one of the logic units receives the output signals of the latching units DFF2 and DFF3, still another one of the logic units receives the output signals of the latching units DFF3 and DFF4, and the last logic unit receives the output signals of the latching units DFF4 and DFF1. The transition point is detected if the output signal of one of the logic units is logic 1. Basically, there should be only one logic unit which outputs logic 1 while the other logic units output logic 0 at any time point, which means a transition point is detected correctly. On the contrary, the transition point is not detected if there are more than one logic units which output logic 1 or none of the logic units outputs logic 1.

The phase selection unit 54 selects one of the reference phases as the data fetch point according to the transition point detected by the transition detection unit 53. The phase selection unit 54 sends the selection result back to the over-sampling unit 52 so that the data latch unit can fetch the input data according to the selected phase and output a fetch result D_OUT.

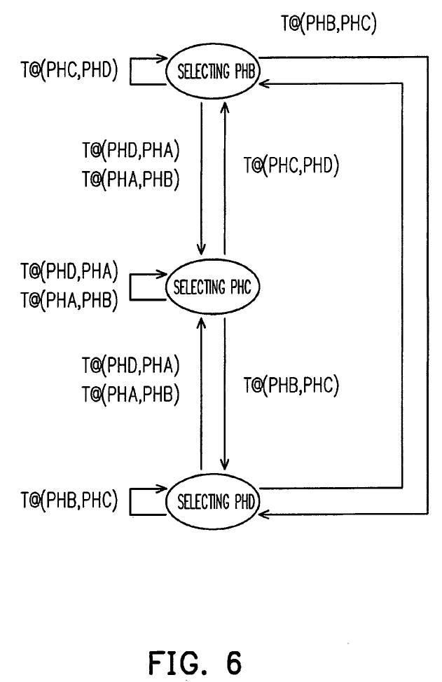

Please refer to FIG. 6 for understanding how to select an appropriate data fetch point. FIG. 6 is a state diagram of the phase selection unit 54. Here, for example, PHC is used as a default data fetch point. The phase selection unit 54 determines the next suitable data fetch point according to the presently selected data fetch point and the detected transition point.

Referring to FIG. 6, how to determine the next data fetch point when PHC is selected as the current data fetch point will be described. PHC is still used as the data fetch point when the detected transition point is between PHA and PHB. PHC is still used as the data fetch point when the detect transition point is between PHD and PHA. PHB is selected as the data fetch point when the detected transition point is between PHC and PHD. PHD is selected as the data fetch point when the detected transition point is between PHB and PHC.

Next, how to determine the next data fetch point when PHB is selected as the current data fetch point will be described. PHB is still used as the data fetch point when the detected transition point is between PHC and PHD. PHC is selected as the data fetch point when the detected transition point is between PHD and PHA. PHC is selected as the data fetch point when the detected transition point is between PHA and PHB. PHD is selected as the data fetch point when the detected transition point is between PHB and PHC.

Next, how to determine the next data fetch point when PHD is selected as the current data fetch point will be described. PHC is selected as the data fetch point when the detected transition point is between PHA and PHB. PHC is selected as the data fetch point when the detected transition point is between PHD and PHA. PHB is selected as the data fetch point when the detected transition point is between PHC and PHD. PHD is still used as the data fetch point when the detected transition point is between PHB and PHC.

In addition, current data transmission fails if the skew between the clock signal and the input data exceeds T/2 (T is the cycle of the input clock), and the problem cannot be resolved by the receiver.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data fetch circuit, receiving an input clock and an input data, the data fetch circuit comprising:
an over-sampling unit, generating a multi-phase clock signal having a plurality of reference phases according to the input clock, the over-sampling unit further over-sampling the input data according to the reference phases;
a transition detection unit, detecting a transition point of the input data; and
a phase selection unit, selecting one of the reference phases of the multi-phase clock signal according to the transition point detected by the transition detection unit, for the over-sampling unit fetching the input data.

2. The data fetch circuit according to claim 1 further comprising:
a control circuit, monitoring the over-sampling unit, the transition detection unit, and the phase selection unit, the control circuit resetting the over-sampling unit, the transition detection unit, and the phase selection unit periodically.

3. The data fetch circuit according to claim 1, wherein the over-sampling unit comprises:
a delay unit, generating the multi-phase clock signal; and
a data latch unit, over-sampling the input data, the data latch unit selecting one of the over-sampling results as the data fetch result according to the reference phase selected by the phase selection unit.

4. The data fetch circuit according to claim 1, wherein the reference phases comprise a first reference phase, a second reference phase, a third reference phase, and a fourth reference phase.

5. The data fetch circuit according to claim 4, wherein the phase selection unit selects the third reference phase when the transition point is between the first reference phase and the second reference phase.

6. The data fetch circuit according to claim 4, wherein the phase selection unit selects the fourth reference phase when the transition point is between the second reference phase and the third reference phase.

7. The data fetch circuit according to claim 4, wherein the phase selection unit selects the third reference phase when the transition point is between the fourth reference phase and the first reference phase.

8. The data fetch circuit according to claim 4, wherein the phase selection unit selects the second reference phase when the transition point is between the third reference phase and the fourth reference phase.

9. The data fetch circuit according to claim 4, wherein a time difference between the second reference phase and the third reference phase is fixed and is related to a timing parameter of the data latch unit.

10. The data fetch circuit according to claim 4, wherein a time difference between the third reference phase and the fourth reference phase is fixed and is related to a timing parameter of the data latch unit.

11. A data fetch method, comprising:
receiving an input clock and an input data;
delaying the input clock to generate a plurality of reference phases;
sampling the input data according to the reference phases;
detecting a transition point of the input data;
selecting one of the reference phases as a data fetch point according to the detected transition point; and
fetching the input data according to the selected data fetch point.

12. The data fetch method according to claim 11, wherein the step of generating the reference phases comprises:
delaying the input clock to generate a multi-phase clock signal, wherein the multi-phase clock signal comprises a first reference phase, a second reference phase, a third reference phase, and a fourth reference phase.

13. The data fetch method according to claim 12, wherein the step of selecting the data fetch point comprises:
selecting the third reference phase when the transition point is between the first reference phase and the second reference phase.

14. The data fetch method according to claim 12, wherein the step of selecting the data fetch point comprises:
selecting the fourth reference phase when the transition point is between the second reference phase and the third reference phase.

15. The data fetch method according to claim 12, wherein the step of selecting the data fetch point comprises:
selecting the third reference phase when the transition point is between the fourth reference phase and the first reference phase.

16. The data fetch method according to claim 12, wherein the step of selecting the data fetch point comprises:
selecting the second reference phase when the transition point is between the third reference phase and the fourth reference phase.

17. The data fetch method according to claim 11 further comprising:
keeping the selected data fetch point when detection of the transition point is failed.
